(19) United States
(12) Patent Application Publication
(10) Pub. No.: US 2003/0078992 A1
(43) Pub. Date: Apr. 24, 2003

(54) Web Pages

(76) Inventors: Andrew David Kirkwood, Manchester (GB); Ian Andrew Newby, Stockport (GB)

Correspondence Address: DURANDO BIRDWELL & JANKE, P.L.C., 2929 E. BROADWAY BLVD., TUCSON, AZ, 85716, US

(21) Appl. No.: 10/240,811

(22) PCT Filed: Apr. 5, 2001
(86) PCT No.: PCT/GB01/01504

(30) Foreign Application Priority Data
Apr. 5, 2000 (GB) 0008232.1

(51) Int. Cl. G06F 15/16

(52) U.S. Cl. 709/218; 715/501.1

(57) ABSTRACT

An improved web page in which a hyperlink object on the web page is linked to a search engine which will search all or any specified web pages to identify those in which that object occurs, or which contains subject matter relevant to that object and these can then be displayed to a user. This allows the user to identify a plurality of relevant web pages which might be of interest rather than being directed only to one specific page, as with a conventional hyperlink.

This invention relates to improvements in or relating to web pages.

Web pages conventionally use so called hyperlink objects to link text or other objects on web pages to other web pages or sites or resources. Usually the hyperlink will, if activated, take a user to one specific web page, to which that link is directed. This can clearly be useful if a user wishes to move quickly to another web page of interest.

However, if a user wishes to identify a number of pages that all relate to the subject of interest, it can be necessary for this user, with conventional hyperlinks, to use hyperlinks on successive pages, if present, to move between relevant pages one after another.

It has been realized by the present applicant that considerable advantage can be obtained by linking the hyperlink object in a web page to a search engine which will then search all or any specified web pages to identify those in which that object occurs, or which contains subject matter relevant to that object and these can then be displayed to a user. In this way, by using a hyperlink object, a user can identify a number of relevant web pages which might be of interest rather than being directed only to one specific page as with a conventional hyperlink.

UK Patent Application GB 2 327 514, International Business Machines Corporation discloses a method of using special ‘directory reference’ hyperlinks in HTML pages. These ‘directory reference’ hyperlinks refer to a specially provided directory lookup service somewhere on the internet.

When the directory hyperlink object is selected by a user the link looks up the distinguishing name in the directory. The link is actioned by an applet and the relevant page is returned. This method has the disadvantage that specific directory orientated hyperlinks must be provided in the source document, the search is limited to a specific directory and it cannot utilize a standard browser since applets or other plug ins are required to implement the search. This known system cannot use a standard hyperlink object in a web page to a search engine in order to conduct a search of the internet or an intranet.

Thus and in accordance with the present invention therefore there is provided an improved web page including at least one hyperlink object, said hyperlink object being directed to a search engine which is operable to identify web pages which contain subject matter relevant to said object and to display at least the addresses of said identified web pages to a user.

With this arrangement it is possible for a user to activate a hyperlink object to gain access to any relevant web pages at the same time.

Preferably the search engine is configured to identify web pages or sites in accordance with specified limitations. Thus for example, if a user is operating on an intranet, the search engine may be configured to search only web pages or sites on that intranet. Alternatively, the search engine may be configured to search only web pages or sites which have a specified address or address parameters.

Preferably the selectively identified web pages or sites are displayed in an order ranked according to their relevance.

Alternatively, the search engine can, if desired, take a user directly to the most, relevant web page or site identified.

The invention will now be described further by way of example only and with reference to the accompanying drawings, in which:

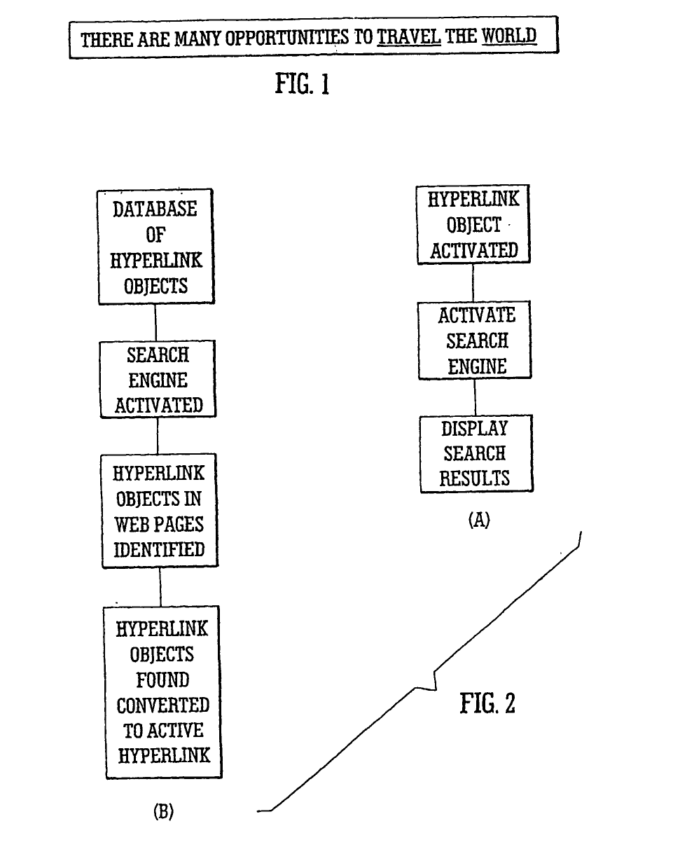

FIG. 1 shows an example of a hyperlink on a web page; and

FIGS. 2a and 2b show flow diagrams showing the mode of operation once a hyperlink object in a web page of the present invention has been selected;

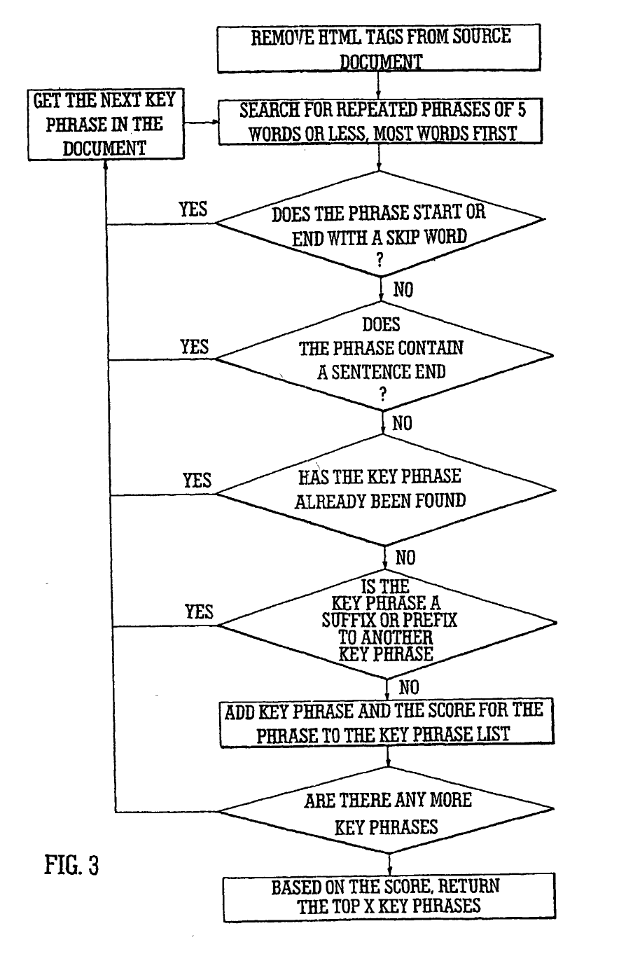

FIG. 3 shows a flow diagram showing the manner of operation of automatic key phrase extraction; and

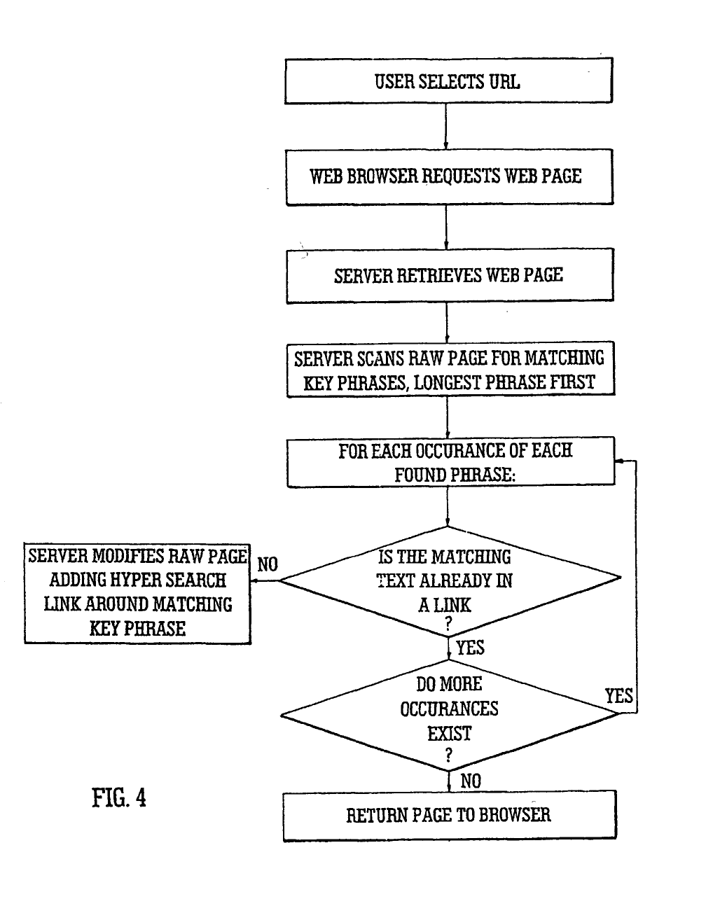

FIG. 4 shows a flow diagram showing the manner of operation of auto document linking.

Referring now to FIG. 1, there is shown a schematic representation of a web page displaying a part sentence of text in HTML format.

Two of the words in the text displayed have, by way of example, been formed into an active hyperlink object. It will of course be appreciated that a hyperlink object can be formed from any appropriate object for example text, graphic, picture as desired or as appropriate. In the present example the text “travel” and the text “world” are formed into hyperlink objects.

As shown in FIG. 2a, if a user activates the hyperlink by for example pointing a cursor over it and clicking their mouse button, a search engine is activated which carries out a search of web pages and sites to ascertain whether any sites contain the object or information relevant to the hyperlink object. Thus for example, if the hyperlink object formed by the text “travel” is activated, then the search engine is activated to search web pages or web sites and identify those which include the word travel or which relate to, or contain subject matter relevant to the topic of travel. Once the search engine has identified the relevant pages or sites, the search engine will then display the addresses of the relevant web pages or sites as conventional hyperlinks and these may or may not be listed ranked in order of relevance.

Alternatively, the search engine can be configured to take a user direct to the most relevant web page or site uncovered as a result of the search carried out.

It will be appreciated that using a hyperlink object to trigger a search engine in the manner mentioned above gives rise to considerable advantages in so far as it removes the necessity for a user to navigate multiple conventional hyperlinks in order to consult all relevant pages or sites in order to ultimately arrive at the most relevant site. Using the present invention it is possible to identify all relevant, including the most relevant, page or site particularly simply and conveniently and it enables a user to quickly identify relevant sites containing the object or information relating hereto.

FIG. 2b shows a further advantage with the present invention. A database of hyperlink objects can be maintained which can be authorized to add hyperlink objects into new web pages or web sites which are found or added onto the web or user's intranet.

One example of how this can be achieved is as follows:

When a hyperlink object is activated by a user, as mentioned above, the search engine will be activated as mentioned above. If when carrying out the search, pages or sites are identified which contain the object, or subject matter relevant to the object being searched, the object found on that page or site is converted into a hyperlink object directed to the search engine, or where relevant subject matter is found on a page or site, a hyperlink object can be inserted onto that page or site. A second example is that the search engine can be suitably configured to carry out a search in relation to all hyperlink objects stored in the database and can, where new pages or sites are found which contain one or more of the objects, or subject matter relevant thereto, either convert the objects into hyperlink objects or add a hyperlink object as appropriate. This search can take place automatically or at a users option.

The search can be further refined by taking into account the context of the current page when the search is performed by automatic keyword/phrase extraction. This is achieved by adding keywords from the current page to the search key. These keywords could be obtained from the metatag or be automatically determined.

In the example illustrated in FIG. 3 the keywords are automatically determined by examining the current page in order to determine a repeated phrase of 5 words or less. The phrase is then checked to ensure that it does not start or end with a skip word, (such as “and” or “the”) and does not contain any punctuation within the sentence or that it is not merely a suffix or a prefix to another key phrase. If the phrase does not meet these criteria, the process is repeated by searching for the next key phrase in the page. If the phrase meets these particular criteria, the phrase is added to a key phrase list and the process is repeated in order to determine further key phrases within the page. When all key phrases have been determined, each of the repeated phrases is ranked according to how many words make up the phrase and how many times the phrase is repeated, and a proportion of the top ranked phrases are returned and used as keywords for that page and added to the search key. This has the advantage that it better defines the parameters of the search and thereby seeks pages more directly relevant to the subject of the current page.

This has the advantage that any document can have the key phrases extracted. Also existing web pages with no keywords can have keywords added.

In a further refinement word stemming is applied to the phrases to remove suffixes, so for example “heat exchanger”, “heat exchangers” and “heat exchanging” could all count as the same phrase. The found phrases could also be checked to ensure that they are syntactically correct with respect to the rules of grammar.

In a further refinement the server is configured to generate a list of key phrases and contains all the key phrases of all the documents the server can link to. Any key phrase that appears in more than one document is considered for auto document linking. The key phrases are obtained either by integrating the keywords metatag or by automatic key phrase extraction as described above. As best illustrated in FIG. 4, when a user requests a web page from the server, the server first loads that page, it then searches for each key phrase in the source document and wraps a hyperobject link around it if possible. This has the advantage that no hard coded hyperlinks are required in the source files. Also, the system is self maintaining, as pages are added to the server, they will be automatically cross-referenced with other pages on that site.

It will be appreciated that a similar approach could be used to add relevant hardlinks to documents when a list of key phrases and matching web pages is held. Furthermore a search site such as a Google could use this approach and act as a portal through which all documents are linked.

It is to be appreciated that the current page may be excluded from the search results.

It will be appreciated that this system means that the hyperlink objects are constantly updated insofar as when the search engine finds new relevant pages or sites, an object found is converted into a hyperlink object or a hyperlink object is inserted. This enables a search to be carried out from these new pages or sites. It will be appreciated that it is possible for the search engine to carry out the update process at any time or in any way as desired or as appropriate.

It will be appreciated that the web page of the present invention and the search engine program will be held on the server of a network system or alternatively in the server of an Internet service provider. It will further be appreciated that when a hyperlink object is activated, the search engine can be configured to search pages and sites in any desired manner. Thus for example, the search engine can be configured to search only the pages or sites contained in an intranet if the user is working on such a system or can be configured to access only pages with certain addresses or address parameters.

It is of course to be understood that the invention is not intended to be restricted to the details of the above embodiment which are described by way of example only.

It is of course to be understood that the invention is not restricted to hyperlink objects in the form of text, but could be also applied to whole or sections of graphic files, video files or audio files etc.

1. An improved web page including at least one hyperlink object, said hyperlink object being directed to a search engine which is operable to identify web pages or sites which contain subject matter relevant to said object and to display at least the addresses of said web pages so identified to a user.

2. A web page according to claim 1, wherein the search engine is configured to identify web pages or sites in accordance with specified limitations.

3. A web page according to claim 2, wherein the search engine is configured to identify web pages or sites on an Intranet.

4. A web page according to claim 2, wherein the search engine is configured to identify web pages or sites which have specified address or address parameters.

5. A web page according to claim 1, wherein said web pages or sites which contain subject matter relevant to said object are displayed in an order ranked according to their relevance.

6. A web page according to claim 1, wherein the search engine is operable to take a user directly to a most relevant web page or site so identified.

7. A web page according to claim 1, wherein the at least one hyperlink object is directed to a database of hyperlink objects adapted to insert hyperlink objects into new relevant pages located by a search of the search engine.

8. A web page according to claim 7, wherein the database of hyperlink objects is adapted to be updated to include new hyperlink objects from new relevant pages located during the search by converting objects from the new relevant pages into new hyperlink objects or by adding newly located hyperlink objects.

9. A web page according to claim 7, wherein the database is held on a server.

10. A web page according to claim 9, wherein the database contains a list of key phrases of all documents the server can link to and is adapted to provide automatic linking between pages containing a same key phrase.

11. A web page according to claim 10, wherein the key phrases are generated by integrating a keyword metatag of new relevant pages so located or by automatic key phrase extraction from the new relevant pages so located.

12. A web page according to claim 1, wherein a context of the web page is adapted to be directed to the search engine.

13. A web page according to claim 12, wherein at least one keyword has been extracted from the web page and added to a search key.

14. A web page according to claim 13, wherein the at least one keyword has been obtained from a keyword metatag or by automatic keyword extraction.

15. A web page according to claim 2, wherein said web pages or sites which contain subject matter relevant to said object are displayed in an order ranked according to their relevance.

16. A web page according to claim 15, wherein the at least one hyperlink object is directed to a database of hyperlink objects adapted to insert hyperlink objects into new relevant pages located by a search of the search engine.

17. A web page according to claim 16, wherein the database of hyperlink objects is adapted to be updated to include new hyperlink objects from new relevant pages located during the search by converting objects from the new relevant pages into new hyperlink objects or by adding newly located hyperlink objects.

18. A web page according to claim 16, wherein the database is held on a server.

19. A web page according to claim 18, wherein a context of the web page is adapted to be directed to the search engine.

20. A web page according to claim 19, wherein at least one keyword has been extracted from the web page and added to a search key.
